(19) United States
(12) Patent Application Publication
(10) Pub. No.: US 2021/0148160 A1
(43) Pub. Date: May 20, 2021

(54) SYSTEM AND METHOD OF A DOOR STOPPER AND WALL PROTECTOR

(71) Applicant: Jeffrey Schon, Antioch, IL (US)

(72) Inventor: Jeffrey Schon, Antioch, IL (US)

(21) Appl. No.: 16/819,026

(22) Filed: Mar. 13, 2020

Related U.S. Application Data
(60) Provisional application No. 62/936,331, filed on Nov. 15, 2019.

(51) Int. Cl. E06B 3/88

(52) U.S. Cl. CPC E06B 3/88; B60R 13/043

(57) ABSTRACT

A surface protection device is provided comprising a shock-absorbent object characterized by a semi-spherical shape, a flat underside, and a flattened area at a topmost point of the object wherein the device attaches to one of a moving object and a stationary object. The device absorbs shock associated with the moving object making contact with the stationary object. The device is continuous and solid and is made of gelatinous synthetic material. The underside of the device is coated with adhesive material and attaches via the underside to the one of the moving object and the stationary object. The shock-absorbency of the device further absorbs noise associated with the contact of the objects and is substantially transparent and unobtrusive.

### CROSS REFERENCE TO RELATED APPLICATIONS

The present disclosure is related to U.S. Provisional Patent Application No. 62/936,331 filed Nov. 15, 2019, the contents of which are included herein in their entirety.

### FIELD OF THE INVENTION

The present disclosure is in the field of household and commercial furnishing accessories. More particularly, the present disclosure provides systems and methods of a door stopper and wall protector device that attaches to a moving or stationary object and protects both from damage while reducing noise usually associated with door use.

### BACKGROUND

Door knobs and other objects attached to doors may damage walls and other fixtures. Doors also cause noise from slamming and banging and are disruptive to conversations, study, enjoyment of television and music, and sleep. Households with young children, large pets, and disabled persons may experience banging of doors that results in damage to walls and furniture. Making repairs to damaged walls and furniture may be expensive and burdensome.

Further, heavy objects may need to be situated on surfaces that may scratch or be subject to damage. When a heavy appliance, for example, needs to be placed on a countertop, the surface may be damaged by the appliance.

### SUMMARY

A surface protection device is provided comprising a shock-absorbent object characterized by a semi-spherical shape, a flat underside, and a flattened area at a topmost point of the object wherein the device attaches to one of a moving object and a stationary object. The device absorbs shock associated with the moving object making contact with the stationary object. The device is continuous and solid and is made of gelatinous synthetic material. The underside of the device is coated with adhesive material and attaches via the underside to the one of the moving object and the stationary object. The shock-absorbency of the device further absorbs noise associated with the contact of the objects and is substantially transparent and unobtrusive.

A system for protection of surfaces comprising a gelatinous, semi-spherically shaped device that attaches to a first stationary object and receives contact from a first moving object. The device absorbs shock associated with the contact, the absorption of shock directed to protection of the objects, and absorbs noise associated with the contact. The first stationary object is a wall surface and the first moving object is a door surface. The device is alternatively attached to the moving object and receives contact with the stationary object. The device has a flat underside coated with adhesive material. The device attaches via the underside to the one of the moving object and the stationary object. The device leaves surfaces unaffected after removal from said surfaces.

A method of providing protection to surfaces is provided comprising a door stopper and wall protection device receiving attachment to a first surface comprising one of a wall, a door, and an item of furniture. The method also comprises the device one of making and receiving contact with a second surface and absorbing shock and noise associated with the contact. The method also comprises the device receiving attachment to the first surface via an adhesive. The second surface is one of a wall, a door, and an item of furniture. The device exhibits a flat underside coated with an adhesive material. The device attaches via the underside to the one of the moving object and the stationary object. The method also comprises the device attaching to a bottom surface of a heavy object to protect a surface upon which the heavy object is placed.

### BRIEF DESCRIPTION OF THE FIGURE

FIG. 1 is an image of a door stopper and wall protector according to an embodiment of the present disclosure.

FIG. 2 is an image of a door stopper and wall protector according to an embodiment of the present disclosure.

FIG. 3 is an image of a door stopper and wall protector according to an embodiment of the present disclosure.

### DETAILED DESCRIPTION

Systems and methods described herein provide a door stopper and wall protector (hereafter “stopper/protector”) comprising a durable, nearly transparent cushion that unobtrusively attaches to doors as well as walls and other stationary objects. The stopper/protector absorbs the shock and noise of a door or other object making contact. The stopper/protector is made of shock absorbent solid gel material that absorbs sound as well as impact.

The stopper/protector may be placed on doors instead of or in addition to stationary objects. When it is not feasible to place the stopper/protector on a surface or object that a door or other object will strike, it may make sense to place the stopper/protector on the door itself.

The stopper/protector is washable and reusable on most clean surfaces. After removal, the stopper/protector in most embodiments does not leave damage or marks on most surfaces and does not affect paint on surfaces.

An adhesive substance on the underside of the stopper/protector facilitates installing the device. A user removes a paper, plastic, metallic or other cover on the underside surface and places the device on a wall or other surface where a door handle would usually make contact.

The stopper/protector also protects walls and other objects from swinging or sliding doors of refrigerators, cabinets, clothes dryers, or showers. In an embodiment, the stopper/protector may be affixed to a door of a vehicle to prevent damage to other vehicles in parking lots or damage to garage walls.

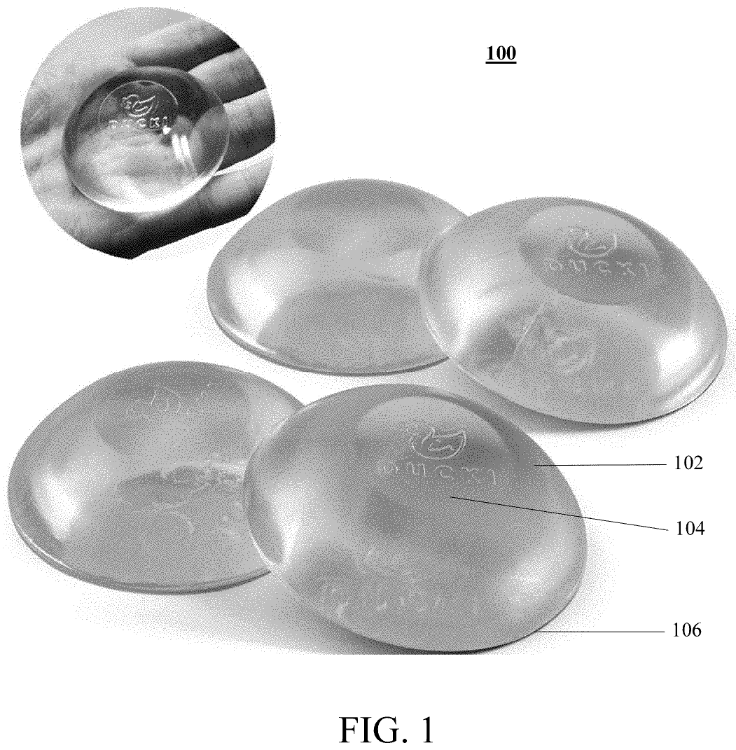

FIG. 1 is an image of several of the stopper/protectors 100 according to an embodiment of the present disclosure. The stopper/protector 100 comprises curved sides 102, a flattened top 104, and an underside 106.

Affixed to the underside 106 is the adhesive material that allows the stopper/protector to be attached to walls, doors, or other objects. The flattened top 104 is the area of the stopper/protector 100 that receives contact and initially absorbs shock of the contact.

Also illustrated in FIG. 1 is the stopper/protector 100 being held in a human hand. The stopper/protector 100 is shown to be several inches in diameter. The nearly transparent characteristic of the stopper/protector may be apparent. In The stopper/protector may be referred to commercially as Ducki.

As noted, alternate embodiments may provide for using the stopper/protector to protect surfaces from heavy objects. In such an example of embodiments not involving doors or walls, a user may attach a stopper/protector to the underside of each corner of a marble slab used for candy making. This slab is placed on top of a granite countertop when used. The stopper/protectors raise the slab up enough to allow a user to get a grip on the marble slab to move it as needed, while keeping enough space between the marble slab and the granite countertops to protect each one from the other. The bumpers stick to the underside of the slab, and enough to the granite countertop the slab is set on so that the slab does not move during use. The stopper/protectors ably support the weight of the marble slab while preventing damage to the granite countertop.

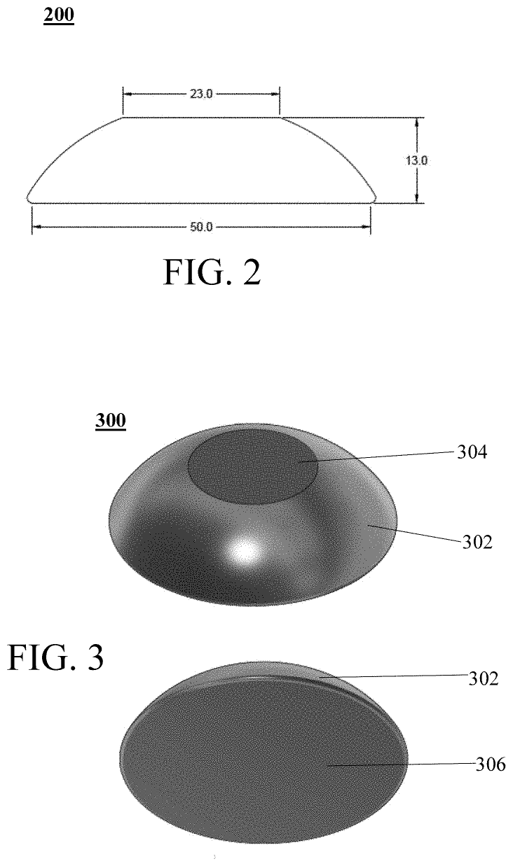

The wall protector/door stopper 100 may be made from a Polyurethane Gel Polymer with the adhesive being part of the material. This allows it to be reused and washed with no degradation to the adhesive powers. Additional uses include applying the wall protector/door stopper 100 to a refrigerator door to prevent damage to and from walls and placing the wall protector/door stopper 100 on the back of a bed headboard to prevent banging on the wall. Components depicted in FIG. 2 and FIG. 3 are indexed to the components depicted in FIG. 1.

FIG. 2 is an image of a door stopper and wall protector according to an embodiment of the present disclosure. FIG. 2 is a diagram with sample dimensions of the wall protector/door stopper 200. The dimensions are in millimeters.

FIG. 3 is an image of a door stopper and wall protector according to an embodiment of the present disclosure. FIG. 3 provides images of the wall protector/door stopper 300 including a top view and an underside view.

What is claimed is:

1. A surface protection device, comprising:
a shock-absorbent object characterized by:
a semi-spherical shape,
a flat underside, and
a flattened area at a topmost point of the object,
wherein the device attaches to one of a moving object and a stationary object.

2. The system of claim 1, wherein the device absorbs shock associated with the moving object making contact with the stationary object.

3. The system of claim 1 wherein the device is continuous and solid.

4. The system of claim 1, wherein the device is made of gelatinous synthetic material.

5. The system of claim 1, wherein the underside of the device is coated with adhesive material.

6. The system of claim 1, wherein the device attaches via the underside to the one of the moving object and the stationary object.

7. The system of claim 1, wherein the shock-absorbency of the device further absorbs noise associated with the contact of the objects.

8. The system of claim 1, wherein the device is substantially transparent and unobtrusive.

9. A system for protection of surfaces comprising:
a gelatinous, semi-spherically shaped device that:
attaches to a first stationary object,
receives contact from a first moving object,
absorbs shock associated with the contact, the absorption of shock directed to protection of the objects, and
absorbs noise associated with the contact.

10. The system of claim 9, wherein the first stationary object is a wall surface and the first moving object is a door surface.

11. The system of claim 10, wherein the device is alternatively attached to the moving object and receives contact with the stationary object.

12. The system of claim 9, wherein the device has a flat underside coated with adhesive material.

13. The system of claim 12, wherein the device attaches via the underside to the one of the moving object and the stationary object.

14. The system of claim 9, wherein the device leaves surfaces unaffected after removal from said surfaces.

15. A method of providing protection to surfaces, comprising:
a door stopper and wall protection device receiving attachment to a first surface comprising one of a wall, a door, and an item of furniture,
the device one of making and receiving contact with a second surface,
the device absorbing shock associated with the contact, and
the device absorbing noise associated with the contact.

16. The method of claim 15, further comprising the device receiving attachment to the first surface via adhesive.

17. The method of claim 15, further comprising the second surface is one of a wall, a door, and an item of furniture.

18. The method of claim 15, further comprising the device exhibiting a flat underside coated with an adhesive material.

19. The method of claim 18, further comprising the device attaching via the underside to the one of the moving object and the stationary object.

20. The method of claim 15, further comprising the device attaching to a bottom surface of a heavy object to protect a surface upon which the heavy object is placed.
